(19) United States
(12) Patent Application Publication
(10) Pub. No.: US 2025/0305358 A1
(43) Pub. Date: Oct. 2, 2025

(54) LADDER BRAKE, SYSTEMS AND METHODS

(71) Applicant: First Due Innovations LLC, Blaine, WA (US)

(72) Inventors: Joel Sellinger, Blaine, WA (US); Benjamin Wesley Docksteader, Custer, WA (US)

(21) Appl. No.: 19/095,721

(22) Filed: Mar. 31, 2025

Related U.S. Application Data
(60) Provisional application No. 63/571,630, filed on Mar. 29, 2024.

(51) Int. Cl. E06C 1/12; B66D 5/32; E06C 7/04

(52) U.S. Cl. CPC E06C 1/12; E06C 7/04; B66D 5/32

(57) ABSTRACT

Aspects of the present disclosure describe systems, methods and devices providing fall protection for movable sections of extension ladders via a ladder brake engaging the halyard.

### CROSS-REFERENCE TO RELATED APPLICATIONS

This application claims the benefit of U.S. Application No. 63/571,630, filed Mar. 29, 2024, the contents of which are incorporated by reference herein in their entirety.

### FIELD

The present technology is directed to ladder brakes, systems and methods, and in exemplary embodiments to systems, methods and devices for ladder brakes that provide for a user to operate an extension ladder using a halyard and pulley system that includes the ladder brake and brake system.

### BACKGROUND

All ladders pose safety risks, especially fire service specific ladders which are wider and heavier than many lightweight construction or homeowner ladders. While raising and lowering the extension ladder the user may lose control of the halyard causing the fly, or extendable sections of the ladder free fall. This free falling can be caused by the user letting go of the halyard in an attempt to keep it from falling, or to stabilize it or by prematurely releasing the halyard before the pawls are engaged. This free-falling can cause severe injury to the user, bystanders, property and to the ladder itself.

A common feature for holding an extendable section of ladder to the bed section uses pawls that lock to the bed section rungs. The pawls need to self-deploy via spring force approximately 1-2 inches above the target rung; then the user must lower the fly section onto the target rung to lock the fly into place. In addition to user error, it is often difficult for the user on the ground to confirm if the pawls are correctly engaged to secure the fly. Additionally, the pawls may malfunction for a variety of reasons including but not limited to: wear or damage, improper or worn spring, or user error when raising or lowering, among others. If the pawl does not properly engage the extendable extension of the ladder can free fall when the halyard is released.

As has been referred to above, typical existing extension ladders, e.g., for firefighter or other service uses, include a number of components, including a halyard to assist in rapidly deploying the ladder in the field when necessary, though significant bodily injury is an ongoing risk when handling, setting up or using such ladders.

PRIOR ART FIG. 1 illustrates an exemplary extension ladder generally at 100, with a base (or bed) ladder section 110 with a side rail 112 and rungs 114, and a fly (movable) section 116 (also with rungs). The bottom of the ladder includes an anti-slip safety shoe or foot 118. An optional rope and pulley system (which may more typically be found on longer models) 120 facilitates extension of the ladder, with rung locks 122 (e.g., pawls or dogs that positively connect to the rungs of the bed or base section of the ladder that is firmly on the ground) providing a catch on successive rungs as the ladder is extended.

While a 2-part ladder is illustrated, this also applies to other multi-part ladders, e.g., 3-part ladders, also contemplated by the present disclosure. As has been noted, in conventional systems, fall or other safety concerns are real. At the least, falls will be 12 inches or so (between rungs), even assuming that the rung locks engage (which is not a given).

Accordingly, there is a need for improved fall protection for any fly sections of an extension ladder or to otherwise provide for safe handling of extension ladders.

### SUMMARY

The present disclosure advantageously provides for systems, methods and devices advantageously providing the needed fall protection for extension ladders, and particularly for any fly section(s) of the extension ladder via a ladder brake engaging the halyard, which overcome the above-described and other problems and disadvantages of the art.

In exemplary aspects, the ladder brake is configured to grab the halyard (it should be noted that the term “halyard” is used interchangeably with the term “rope” and encompasses similar such devices as may be used for such purposes on an extendable ladder, e.g., a cable), preventing movement any time the halyard does not have any tension on it, and to release the halyard to allow movement in either direction when tension is applied.

In exemplary aspects described herein, the brake system replaces the typical single pulley that is attached to the top rung of the bed section (though we note that this could also attach in other locations). The brake system provides a pulley design that includes a brake component.

In exemplary aspects, the ladder brake holds the halyard in place any time that tension is not applied to the halyard. In further exemplary embodiments, the ladder brake does not engage when tension is applied in either direction. For example, during use, a user can raise the fly section and then release halyard tension, which locks the halyard into position. Reapplying tension (e.g., with a slight pull down on the halyard) releases the brake, restoring normal functionality, and allows the user to either further raise or lower the extension ladder in a safe and controlled manner. Accordingly, exemplary embodiments provide an automatic braking system to arrest the fall of a movable section of an extension ladder (e.g., if the halyard is released without pawls engaged or if any other issues arise). Similarly, if the user loses control of the halyard (e.g., it slips), the braking system will automatically engage to lock the fly section in place since the required tension is no longer on the halyard.

In further exemplary aspects, the ladder brake/system creates a tortuous path for the rope. An exemplary brake arm retracts any time the rope has tension and is applied any time the rope does not have tension (e.g., if the rope comes loose or a user loses grip on the rope). In further exemplary aspects, this applies regardless of the direction of tension on the rope (tension, or at least tension above a predetermined amount, either way will release the brake).

In exemplary aspects, the halyard is attached to a lower rung (e.g., the base rung) of the fly section and routed over the top of the bed section through a pulley that is attached to an upper (e.g., the top) rung of the bed section. The halyard routing returns back on the bed section side of the extension ladder, where the user can pull on the halyard to move the fly section, thus extending or decreasing the overall length of the ladder.

In exemplary aspects, tension above a predetermined amount accounts for natural forces on ladder in a normal operating state such that the brake does not incidentally disengage, e.g., due to vibration, the weight of the rope, drag on the rope or other forces or stresses applied while one or more users (and possibly their gear) pass up or down the ladder, etc. In further exemplary aspects, this is performed by the design of the brake component, e.g., using a rotatable arm or a spring-loaded translational arm having a configuration that requires a threshold amount of tension on the rope prior to disengagement.

In exemplary aspects, the braking system includes a base plate or housing that holds, locates and protects the functional parts and provides a braking surface, e.g., a movable brake arm using linear or rotational spring force to engage the halyard. The system also includes a pully to route the halyard therethrough. A cover plate may be provided to give additional structure and protection to the components. In further exemplary aspects, the braking surface and/or movable arm may also include texture, e.g., sharpened inserts, grooves, etc., to provide optimal grip on the halyard. Additionally, one or more of the system components can be removable.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

PRIOR ART FIG. 1 is a perspective view of a traditional extension ladder with a halyard and pulley;

FIG. 2 is a front elevation view of an exemplary braking system, in accordance with embodiments of the present disclosure;

FIG. 3 is a perspective schematic view of aspects of the exemplary braking system of FIG. 2;

FIG. 4 is a breakaway perspective view of an exemplary braking system, in accordance with embodiments of the present disclosure;

FIG. 5 is another breakaway perspective view of the exemplary braking system of FIG. 4;

FIG. 6 is front elevation view of the exemplary braking system of FIG. 4;

FIG. 7 is another front elevation view of the exemplary braking system of FIG. 4;

FIG. 8 is a perspective view of an exemplary braking system, in accordance with embodiments of the present disclosure;

FIG. 9 is a breakaway perspective view of the exemplary braking system of FIG. 8;

FIG. 10 is a front elevation view of an exemplary braking system, in accordance with embodiments of the present disclosure;

FIG. 11 is a front elevation view of the exemplary braking system of FIG. 10;

FIG. 12 is a front elevation view of an exemplary braking system, in accordance with embodiments of the present disclosure;

FIG. 13 is a front elevation view of the exemplary braking system of FIG. 12;

FIG. 14 is a perspective view of an exemplary braking system with a rotation limiting aspect, in accordance with aspects of the present disclosure; and

FIG. 15 is a perspective view of an actuated position for the exemplary braking system of FIG. 14.

### DETAILED DESCRIPTION

Reference will now be made in detail to the exemplary embodiments and exemplary methods as illustrated in the accompanying drawings, in which like reference characters designate like or corresponding parts throughout the drawings. It should be noted, however, that the invention in its broader aspects is not necessarily limited to the specific details, representative materials and methods, and illustrative examples shown and described in connection with the exemplary embodiments and exemplary methods.

This description of exemplary embodiments is intended to be read in connection with the accompanying drawings, which are to be considered part of the entire written description. In the description, relative terms such as “horizontal,” “vertical,” “front,” “rear,” “upper”, “lower”, “top” and “bottom” as well as derivatives thereof (e.g., “horizontally,” “vertically,” “downwardly,” “upwardly,” etc.) should be construed to refer to the orientation as then described or as shown in the drawing figure under discussion and to the orientation relative to door, door frame, etc. These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. The term “integral” (or “unitary”) relates to a part made as a single part, or a part made of separate components fixed (i.e., non-moveable) and connected together. Additionally, the word “a” and “an” as used in the claims means “at least one” and the word “two” as used in the claims means “at least two.”

As we have noted and without limitation, the present disclosure relates to systems, methods and devices advantageously providing the needed fall protection for extension ladders, and particularly for any fly section(s) of the extension ladder via a ladder brake engaging the halyard, which overcome the above-described and other problems and disadvantages of the art.

In exemplary aspects, the ladder brake is configured to grab the halyard (again, it should be noted that the term “halyard” is used interchangeably with the term “rope” and encompasses similar such devices as may be used for such purposes on an extendable ladder, e.g., a cable), preventing movement any time the halyard does not have any tension on it and to release the halyard to allow movement in either direction when tension is applied.

In exemplary aspects described herein, the brake system replaces the typical single pulley that is attached to the top rung of the bed section (though we note that this could also attach in other locations). The brake system provides a pulley design that includes a brake component.

In exemplary aspects, the ladder brake holds the halyard in place any time that tension is not applied to the halyard. In further exemplary embodiments, the ladder brake releases when tension is applied in either direction. For example, during use, a user can raise the fly section and then release halyard tension, which locks the halyard into position. Reapplying tension (e.g., with a slight pull down on the halyard) releases the brake and allows the user to either further raise or lower the extension ladder in a safe and controlled manner. Accordingly, exemplary embodiments provide an automatic braking system to arrest the fall of a movable section of an extension ladder (e.g., if the halyard is released without pawls engaged or if any other issues arise). Similarly, if the user loses control of the halyard (e.g., it slips), the braking system will automatically engage to lock the fly section in place since the required tension is no longer on the halyard.

In further exemplary aspects, the ladder brake/system creates a tortuous path for the rope. An exemplary brake arm retracts any time the rope has tension and is applied any time the rope does not have tension (e.g., if the rope comes loose or a user loses grip on the rope). In further exemplary aspects, this applies regardless of the direction of tension on the rope (tension, or at least tension above a predetermined amount, either way will release the brake).

In exemplary aspects, the halyard is attached to a lower rung (e.g., the base rung) of the fly section and routed over the top of the bed section through a pulley that is attached to an upper (e.g., the top) rung of the bed section. The halyard routing returns back on the bed section side of the extension ladder, where the user can pull on the halyard to move the fly section, thus extending or decreasing the overall length of the ladder.

In exemplary aspects, tension above a predetermined amount accounts for natural forces on ladder in a normal operating state such that the brake does not incidentally disengage, e.g., due to vibration, the weight of the rope, drag on the rope or other forces or stresses applied while one or more users (and possibly their gear) pass up or down the ladder, etc. In further exemplary aspects, this is performed by the design of the brake component, e.g., using a rotatable arm or a spring-loaded translational arm having a configuration that requires a threshold amount of tension on the rope prior to disengagement.

In exemplary aspects, the braking system includes a base plate or housing that holds, locates and protects the functional parts and provides a braking surface, e.g., a movable brake arm using linear or rotational spring force to engage the halyard. The system also includes a pully to route the halyard therethrough. A cover plate may be provided to give additional structure and protection to the components. In further exemplary aspects, the braking surface and/or movable arm may also include texture, e.g., sharpened inserts, grooves, etc., to provide optimal grip on the halyard. Additionally, one or more of the system components can be removable.

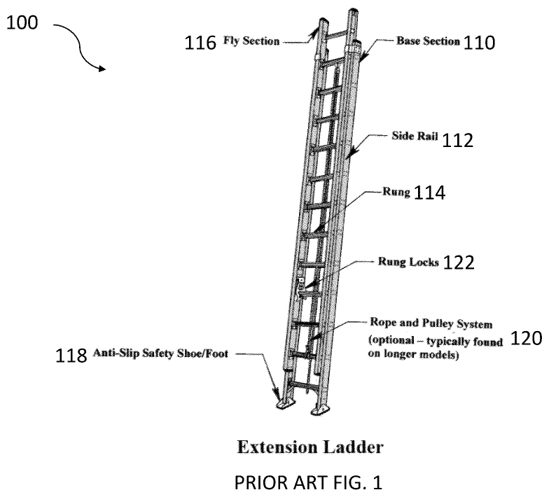

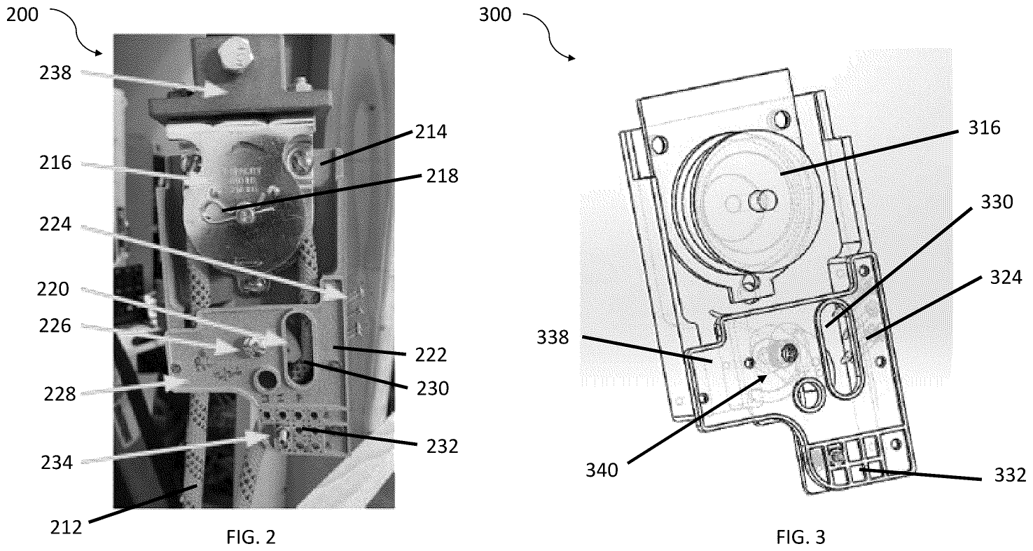

FIG. 2 is a front elevation view of an exemplary braking system (shown generally at 200) with a halyard 212 installed therein. This exemplary embodiment presents a housing with a base plate 214, which mounts a pulley 216 (note that the pulley includes a cotter pin 218, emphasizing that various components can be configured to be removed and replaced). The braking component 220 in this embodiment is a rotary style component, biased to press the halyard against braking surface 222 in an un-tensioned state. We note that in this embodiment, the braking surface is augmented by adjustable/removable/replaceable spikes 224 to assist in holding the halyard in that un-tensioned state. A torsion spring (not shown in FIG. 2) is provided behind screw 226. An exemplary cover plate 228 is also shown providing at least one inspection opening/aperture 230, as well as various apertures 232 allowing for selective routing of the halyard (adjustment of the path through the housing) via one or more set pins or fasteners 234. A ladder rung attachment member is also provided on the housing (in this case bolted thereto, with hardware to attach it to a ladder rung), generally at 236.

FIG. 3 is a schematic view, shown generally at 300, of exemplary aspects shown in FIG. 2, e.g., noting the pulley 316, the inspection aperture 330, a different exemplary configuration of plural halyard routing apertures 332 and a view of the adjustable/removable/replaceable spikes 224 (noting that these can be set to certain depths as desired in exemplary embodiments). The rotatable brake component and bias member can also be seen in phantom, generally at 340 beneath the cover plate 338.

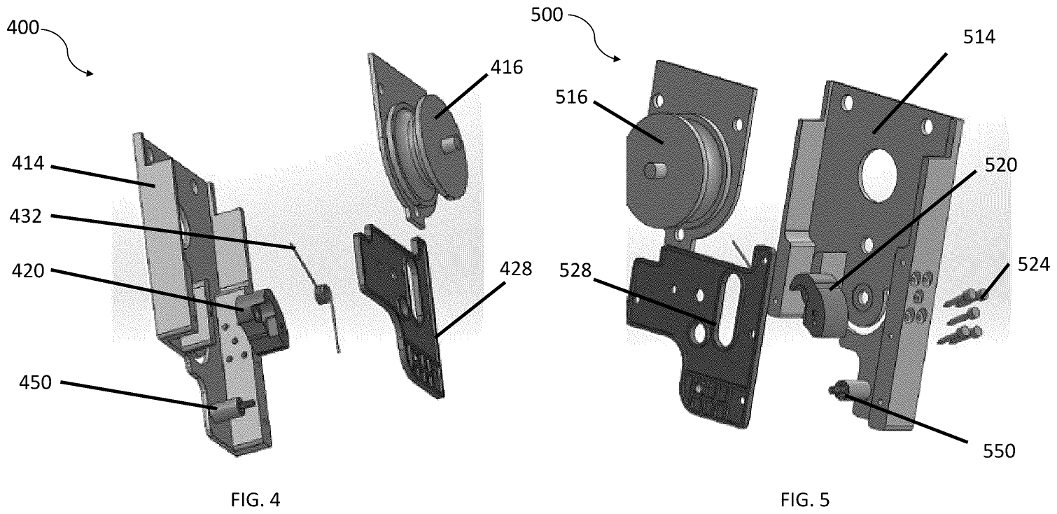

FIG. 4 illustrates at 400 an expanded perspective view showing exemplary components generally at 400 of the brake system of FIGS. 2 and 3 in more detail. Base plate 414 includes an exemplary mount 450 for the braking component 420 (note the cylindrical surface thereof for rotation around that mount), along with a biasing member 452. Cover plate 428 and pulley 416 are also illustrated.

FIG. 5 is also at 500 an expanded perspective view of an exemplary system, showing the base plate 514, the mount 550 for the braking component 520, the cover plate 528 along the adjustable/removable/replaceable spikes 524.

FIG. 6 illustrates at 600 another exemplary exemplary embodiment in accordance with aspects described herein, with a base plate 614, a pulley 616, a braking component 620, a braking surface/wall 622 with grabbing texture/contours 654, with the halyard 612 running therethrough.

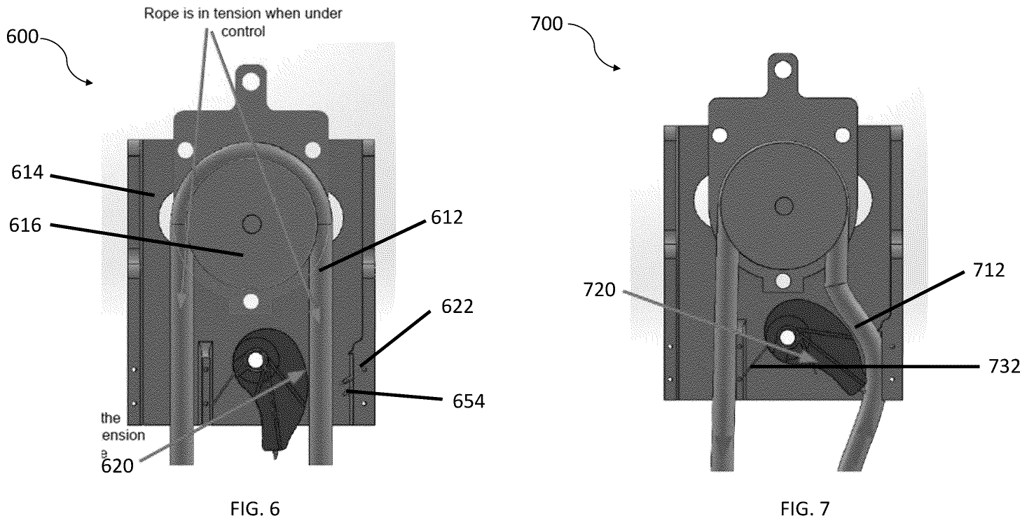

FIG. 7 is at 700 another exemplary embodiment showing the device of FIG. 6 with the braking component 720 engaged, with the action of the force created by the spring 732, creating a greater curved path for the halyard 712 therearound.

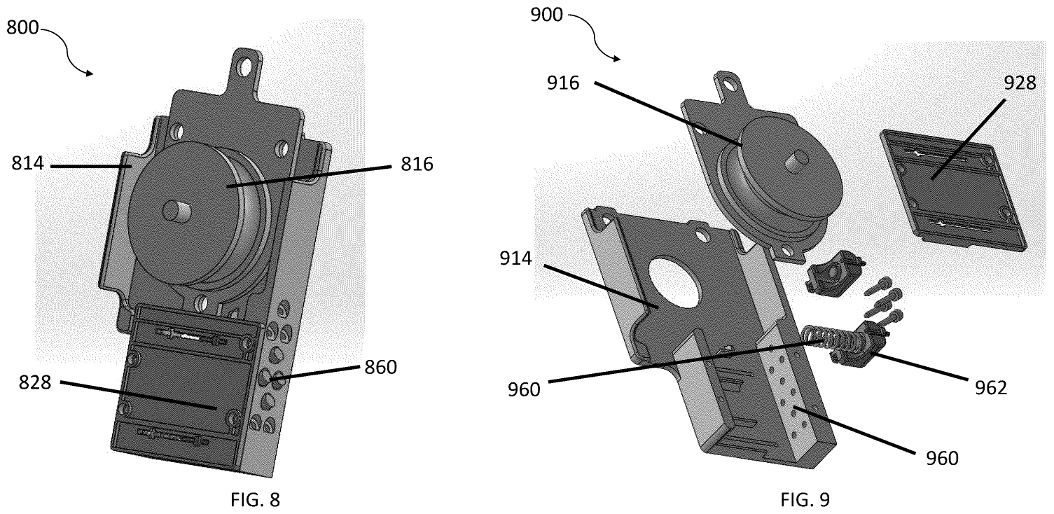

FIG. 8 illustrates at 800 another exemplary embodiment, with a linear brake component (not illustrated). In general, that FIG. shows the pulley 816, the housing 614, a cover 828 and various halyard engaging apertures for texture/protrusion/spike engagement of the halyard when it is in an un-tensioned state.

FIG. 9 illustrates at 900 a similar deconstructed image with the housing 914, the pulley 916, the cover plate 928, and also illustrating exemplary holes 960 for texture/protrusion/spike engagement of the halyard, and spring bias (linear) components 960 for brake 962.

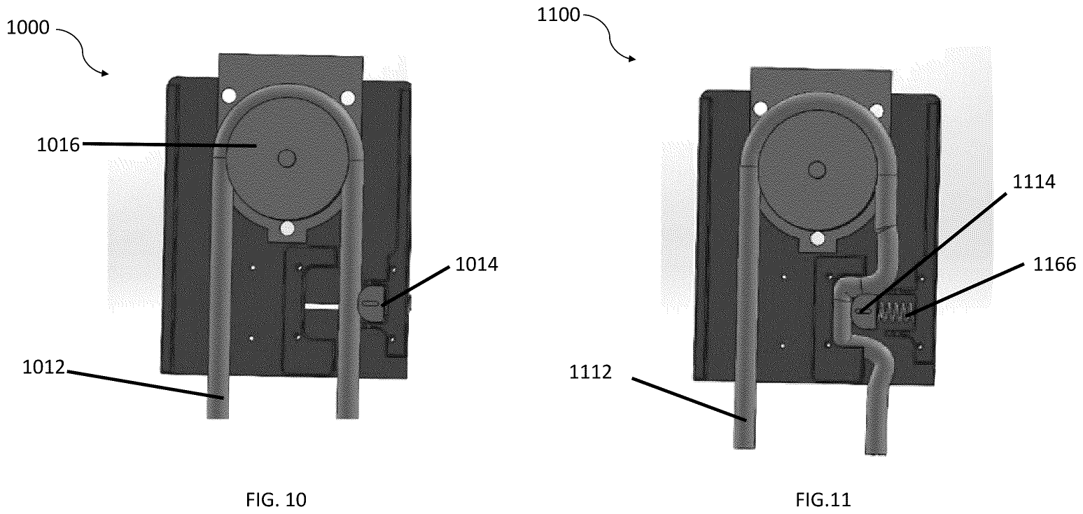

FIG. 10 illustrates at 1000 a front elevation view of the exemplary linear brake design of FIG. 9, with the pulley 1016, the halyard 1012, and the braking component 1014, which in this case is biased open due to tension on the halyard 1012, allowing movement in either direction.

FIG. 11 illustrates at 1100 the device of FIG. 10 in a halyard-untensioned state, with the halyard 1112 engaged with the braking component 1114 (with bias by spring 1166), and creating a further tortuous path (beyond that of the pulley or any housing pins/directing members, etc.) (note the creation of the markedly curved path during the period of no tension in FIG. 11 relative to FIG. 10.

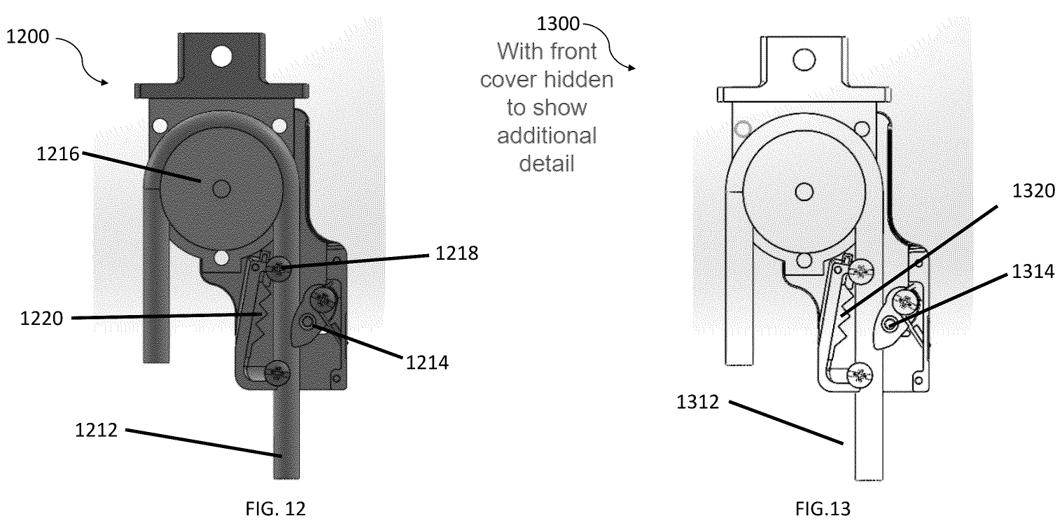

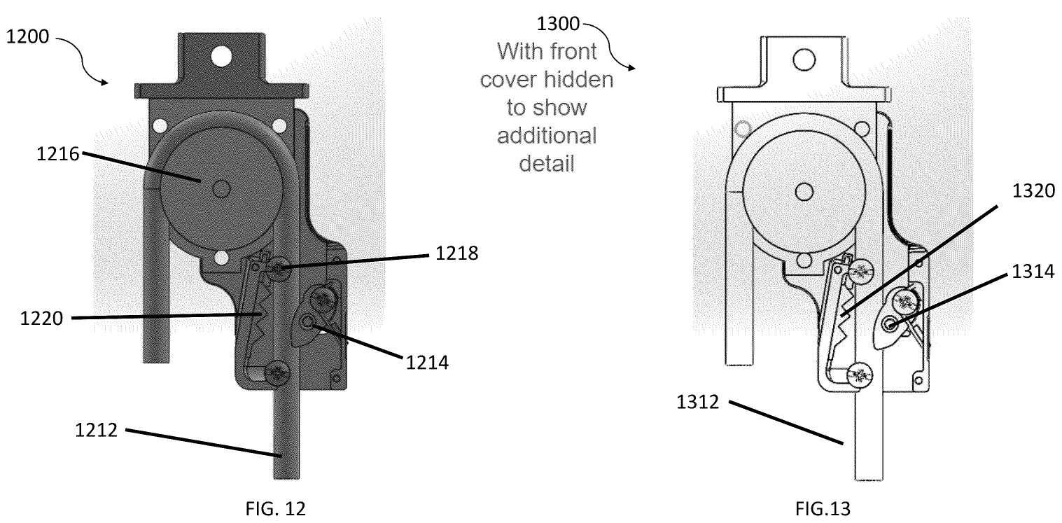

FIG. 12 illustrates at 1200 a front elevation view of another exemplary brake design similar to the rotary arm design in FIGS. 4-6, but with the mechanism reversed, which configuration can advantageously reduce additional friction that the mechanism creates when the ladder is used in the normal state and reducing friction fatigue concerns. The exemplary embodiment shows pulley 1216, the halyard 1212, and the braking component 1214, which in this case is biased open due to tension on the halyard 1012, allowing movement in either direction. Guides and/or cover fasteners 1218 and gripping teeth 1220 are also shown for when the braking component 1214 is in the engaged state. FIG. 13 similarly shows at 1300, halyard 1312, braking component 1314 and gripping teeth 1320 in an un-braked configuration.

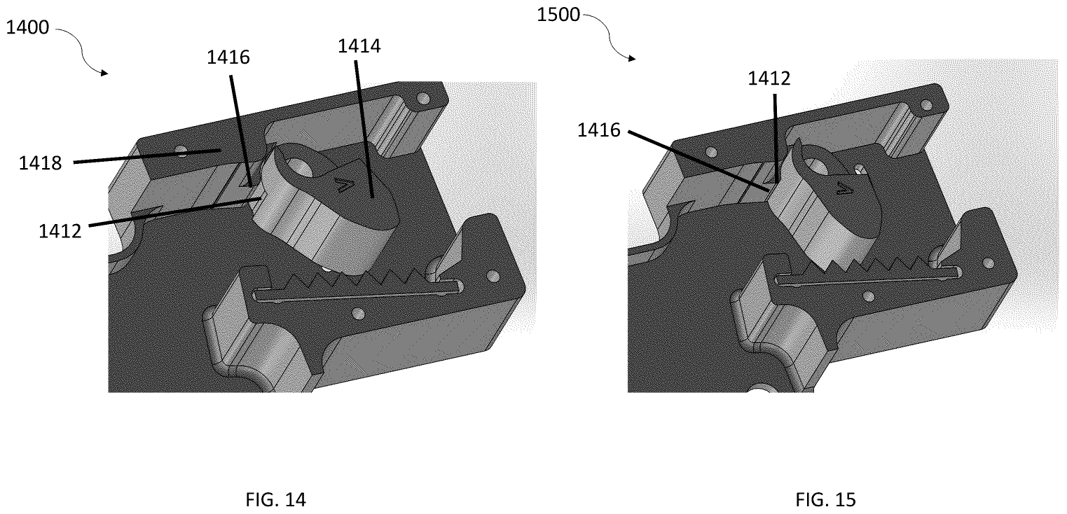

In any of these exemplary rotary arm designs, the rotation of the braking component 1214 can be limited, e.g., by the interface between the arm and the main body so that the arm cannot over rotate and jam with the rope during braking. This can be by virtue of the distances between the rotary arm and the body, any assistive contouring between the rotary arm and the body to limit over rotation of the rotary arm, or any other rotation-limiting aspect. In such exemplary embodiments, re-setting of the device after a fall activation can be done more efficiently and with less force, improving user experience without limiting stopping power. FIG. 14 shows such a limiting feature generally at 1400 as a notch 1412 in the rotary arm 1414 not yet engaged with a contour 1416 on a wall of the main body 1418. FIG. 15 shows generally at 1500 engagement of the notch 1412 and the contour 1416,

The descriptions of the various aspects of the present invention have been presented for purposes of illustration but are not intended to be exhaustive or limited to the aspects disclosed. Many modifications and variations will be apparent to those of ordinary skill in the art without departing from the scope and spirit of the described aspects. The terminology used herein was chosen to best explain the principles of the aspects, the practical application or technical improvement over technologies found in the marketplace, or to enable others of ordinary skill in the art to understand the aspects described herein.

Various aspects of the invention are described herein with reference to the related drawings. Alternative aspects of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains,” or “containing,” or any other variation thereof are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any aspect or design described herein as “exemplary” is not necessarily to be construed as preferred or advantageous over other aspects or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof are intended to include the degree of error associated with measurement of the particular quantity based upon the equipment available at the time of filing the application. For example, “about” can include a range of ±8% or 5%, or 2% of a given value.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, extension ladder or fall protection systems.

What is claimed is:

1. An extension ladder braking system, comprising:
an extension ladder, comprising: a base section, at least one movable section and a halyard connected to the base and movable sections; and
a braking component, comprising a housing including a pulley and a braking component, wherein the housing is configured to accept the halyard in a tortuous path, around the pulley and past the braking component, the braking component being biased against the halyard such that it holds the halyard in place when the halyard is in an untensioned state and such that the bias of the braking component is overcome when the halyard in a tension state, allowing the halyard to move past the braking component.

2. An extension ladder braking system in accordance with claim 1, wherein the biased braking component comprises a movable arm that is biased according to a linear or rotational bias member.

3. An extension ladder braking system in accordance with claim 2, wherein bias member provides a linear braking force.

4. An extension ladder braking system in accordance with claim 1, wherein the bias member provides a rotational braking force.

5. An extension ladder braking system in accordance with claim 1, wherein the housing routes the halyard around the pulley and down past the braking component.

6. An extension ladder braking system in accordance with claim 5, wherein the housing further defines an at least partially curved path around the braking component when the halyard is in an un-tensioned state.

7. An extension ladder braking system in accordance with claim 6, wherein the curvature of the path changes dependent upon the tension applied to the halyard, such that tension shallows the curvature of the path by moving against the bias of the braking component.

8. An extension ladder braking system in accordance with claim 1, wherein the housing includes a base plate holding the pulley and braking component in place and defining the tortuous halyard path.

9. An extension ladder braking system in accordance with claim 8, wherein the housing includes a cover plate opposite the base plate.

10. An extension ladder braking system in accordance with claim 9, wherein the cover plate is removable to allow inspection or replacement of component parts.

11. An extension ladder braking system in accordance with claim 1, wherein the braking component cooperates with an opposite braking surface to secure the halyard when the halyard is in an un-tensioned state.

12. An extension ladder braking system in accordance with claim 11, wherein the one or both of the braking component and the braking surface includes texturing to grip the halyard.

13. An extension ladder braking system in accordance with claim 12, wherein the texturing includes sharpened inserts.

14. An extension ladder braking system in accordance with claim 13, wherein the sharpened inserts are replaceable.

15. An extension ladder braking system in accordance with claim 1, wherein the braking component includes texturing to grip the halyard.

16. An extension ladder braking system in accordance with claim 15, wherein texturing includes sharpened inserts.

17. An extension ladder braking system in accordance with claim 16, wherein the sharpened inserts are replaceable.

18. An extension ladder braking system in accordance with claim 1, wherein the housing further comprises a ladder rung attachment component.

19. An extension ladder braking system in accordance with claim 9, wherein the cover plate further includes one or more inspection openings.

20. An extension ladder braking system in accordance with claim 1, wherein the housing further comprises plural routing pin paths, allowing selective direction of the halyard pathway.
